(19) United States
(12) Patent Application Publication
(10) Pub. No.: US 2021/0119877 A1
(43) Pub. Date: Apr. 22, 2021

(54) System and Method for Predictive Grouping and Presentation of Target Devices in a Storage Router

(71) Applicant: ATTO Technology, Inc., Amherst, NY (US)

(72) Inventors: David A. Orr, Niagara Falls (CA); David J. Cuddihy, Hamburg, NY (US); David A. Snell, Youngstown, NY (US)

(21) Appl. No.: 17/077,678

(22) Filed: Oct. 22, 2020

Related U.S. Application Data
(60) Provisional application No. 62/973,740, filed on Oct. 22, 2019.

(51) Int. Cl. H04L 12/24; G06F 13/42; G06F 21/44; H04L 29/08

(52) U.S. Cl. CPC H04L 41/12; G06F 13/4282; G06F 2213/0032; H04L 67/1097; G06F 2213/0028; G06F 21/44

(57) ABSTRACT

An improved system and method within a storage area network (SAN) for establishing predictive grouping and presentation of target devices contained within the same physical enclosure(s) in an iSCSI/iSER to SAS/SATA storage router. Target devices within an enclosure are dynamically discovered in slot order and placed in an iSCSI/iSER storage node to facilitate access by SAN initiator devices.

### RELATED APPLICATIONS

This application claims priority to and the benefit of U.S. Provisional Application No. 62/973,740, filed Oct. 22, 2019, incorporated herein by reference in its entirety.

### TECHNICAL FIELD

The present invention relates generally to computer systems and, more particularly, to computer storage systems and methods for grouping and presentation of target devices in a storage router.

### BACKGROUND OF THE INVENTION

In a stand-alone computer, data is stored in a device such as a hard disk drive. This device is normally internal to the computer and has a connection to the CPU by an internal bus.

In a network environment, the data generated by a workstation may be stored on a remote device. The data storage device connects to the workstation by a network that is external to the workstation and is accessible by a number of devices. A Storage Area Network, hereafter referred to as a “SAN,” consists of initiators, typically workstations or servers, and targets, such as a disk drive array, tape library or other storage resources and components. Each component of the SAN has an address that allows network storage traffic to be routed to and from the appropriate end nodes.

SANs may use different protocols to accomplish network storage routing. On the initiator side, SAN protocols include Fibre Channel, Internet Small Computer Systems Interface (iSCSI), iSCSI Extensions for RDMA (iSER), Non-Volatile Memory Express over Fabrics (NVMeOF), and Non-Volatile Memory Express over Fibre Channel (FC-NVMe). A SAN's target side usually consists of a large number of devices based on several drive storage technologies, including Serial Attached SCSI (SAS), Serial Advanced Technology Attachment (SATA), and Non-Volatile Memory Express (NVMe). These target devices, including without limitation disk drives, tape drives, solid-state drives, optical storage and protocol expanders, connect to a SAN via a storage router that provides protocol translation and target device aggregation. Storage routers, also commonly known as protocol bridges or gateways, are responsible for presenting target devices into the SAN namespace in order to provide seamless connectivity between initiators and targets.

On a SAN, a storage router exposes connected target devices, each having a unique identifier. A target may contain one or more Logical Unit Numbers (LUNs). LUNs can represent a single physical device, a portion of a physical device, or a logical device created by the concatenation of storage from several different physical devices.

U.S. Pat. No. 7,447,197 B2 (Terrell et al.) teaches a method for dynamic discovery of target devices in an unpredictable manner. U.S. Pat. No. 8,504,770 B2 (Cuddihy et al.) discloses a system for representation of target devices in a storage router. Cuddihy et al. is incorporated herein by reference in its entirety, except for any definitions, subject matter disclaimers or disavowals, and except to the extent that the incorporated material is inconsistent with the express disclosure herein, in which case the language in this disclosure controls.

### BRIEF SUMMARY OF THE INVENTION

Merely for purposes of illustration and not by way of limitation, the invention broadly comprises a system, method and mechanism within a storage router for establishing predictive grouping and SAN presentation of target devices (e.g. SAS and SATA-based target devices) contained within the same physical enclosure.

As used herein, the phrase “SAS/SATA interface” means a computer bus interface for connecting to SAS and SATA storage. As used herein, the phrase “iSCSI/iSER host system interface” means a computer network interface for connecting initiator devices to target storage devices.

In one aspect, the storage router disclosed herein is communicatively connectable to a plurality of target storage devices having a physical layout. In another aspect, the storage router comprises an expansion processor within a storage enclosure; a router discovery module in communication with the expansion processor, configured to discover the physical layout of target storage devices within the storage enclosure; a iSCSI/iSER host system interface for receiving and responding to data storage commands; a SAS/SATA interface for communicating with target storage devices; and storage nodes which contain device maps corresponding to the physical layout of the target storage devices.

In another aspect, the storage enclosure is configured to report an enclosure identifier and to report said physical layout by means of an associated characteristic parameter, as discussed below. In yet another aspect, iSCSI/iSER host system interface storage nodes contain target storage device maps grouped by enclosure identifier and ordered by associated characteristic parameters. In certain aspects, the associated characteristic parameter is target device slot number or target PHY identifier. Host system interface storage nodes and target storage device maps may also be stored in nonvolatile storage to preserve a consistent view across storage router failures, power-cycles, resets or re-cabling.

In one aspect, the storage router disclosed herein comprises an empty target device map to account for gaps in the associated characteristic parameter(s).

A method of mapping target storage devices in a storage router system is also provided. In certain aspects, the method includes the following steps: providing an iSCSI/iSER host system interface for receiving and responding to data storage commands; providing a plurality of target storage devices; discovering the physical layout of said target storage devices; and creating a plurality of iSCSI/iSER host system interface storage nodes containing target storage device maps corresponding to the physical layout of the target storage devices. The method may also include one or more of the following: (a) providing nonvolatile storage; (b) writing host system interface storage nodes and target storage device maps to nonvolatile storage such that a consistent view is preserved across storage router failures, power-cycles, resets or re-cabling; (c) providing a plurality of storage enclosures configured to report an enclosure identifier and to report the physical layout by means of an associated characteristic parameter; (d) querying storage enclosures to report said enclosure identifier(s) and characteristic parameter(s), wherein the host system interface storage nodes are created and where target device maps are grouped by enclosure identifier(s) and characteristic parameter(s); (e) wherein the characteristic parameter(s) may include target device slot number or target PHY identifier; (f) analyzing characteristic parameter(s) for gaps, (g) creating an empty storage device map to account for gaps; (h) copying, renaming, and deleting storage nodes, and/or (i) manual addition and removal of target storage device maps within storage nodes.

A system within a storage area network for establishing predictive grouping and presentation of target devices contained within a single physical enclosure is also provided. In certain aspects, the system includes a storage router in communication with a plurality of initiators; a plurality of target storage devices in a storage area network; a physical storage enclosure containing more than one of said target storage devices; a router discovery module within a storage router configured to discover the physical layout of target storage devices and to discover which of the target storage devices are contained within the same physical storage enclosure; a storage node comprising a plurality of target devices and a list of initiator devices that have access privileges to the target devices, wherein the storage node corresponds to the discovered single physical storage enclosure; and wherein said storage router presents said first storage node to one or more of said initiators. In other aspects, the system includes (a) an expansion processor in communication with said router discovery module; (b) two or more physical storage enclosures; (c) unique storage nodes comprising a plurality of target devices and a list of initiator devices that have access privileges to target devices, which storage node corresponds to separate physical storage enclosures; and/or (d) wherein the storage router is an iSCSI/iSER to SAS/SATA storage router.

### BRIEF DESCRIPTION OF THE DRAWINGS

FIG. 1 is a diagram of one embodiment of a storage router in an iSCSI SAN environment, with multiple initiators connected to the SAN along with an iSCSI storage router installed between a number of SAS enclosures and the SAN.

FIG. 2 describes the flow of an exemplary target discovery algorithm. In this example, a storage node is created for each discovered storage enclosure, and all targets and LUNs within the enclosure are added to its storage node.

### DESCRIPTION OF THE PREFERRED EMBODIMENTS

At the outset, it should be clearly understood that like reference numerals are intended to identify the same parts, steps, elements or portions consistently throughout the drawing figures, as such parts, steps, elements or portions may be further described or explained by the entire written specification, of which this detailed description is an integral part. The following description of the preferred embodiments of the present invention is exemplary in nature and not intended to restrict the scope of the present invention, the manner in which the various aspects of the invention may be implemented, or their applications or uses.

In one embodiment of the invention, a storage router associates initiators and targets into a storage node—defined herein as a collection of target devices and a list of initiator devices that have access privileges to those targets. In one aspect, the presentation of storage nodes is the responsibility of the storage router, and may be configured manually by the user or automatically by the storage router. General-purpose operating systems are not very tolerant of unexpected target device additions or removals, so it is preferred that devices presented on the SAN do not change storage node, target or LUN assignments without specific user intervention.

Target devices may be housed in physical enclosures along with an expansion processor. Such an expansion processor communicates with multiple devices, enabling a single enclosure connection to communicate with multiple targets. In certain aspects, target devices in an enclosure are identified by a slot number known to the expansion processor. The storage router employs a router discovery module to identify, enumerate, and establish communications with expansion processors on the SAN. Once an expansion processor is discovered, each target's slot number may be determined by querying the processor. This is useful since enclosures may contain unused targets and unoccupied slots to provide for target failover and future expansion. The storage router may also be configured to automatically create a unique storage node for the expansion processor and predictively group all target devices associated with that processor within its storage node. This is useful to ease the management burden on network administrators during configuration of SANs where multiple enclosures containing a large number of targets are deployed. Storage nodes may also be copied and renamed for further administrator flexibility and ease of management

A preferred embodiment of the invention implements storage router grouping and presentation of target devices into the SAN namespace whereby identification, location, and topology characteristics of target devices (logical enclosure identifier, target identifier, PHY identifier, and device slot numbers), referred to herein as “associated characteristic parameters,” can be determined and recorded. Storage router groupings of target devices (storage nodes) are subsequently presented to initiators on the SAN. In the preferred embodiment (see descriptions in paragraphs [0021] and [0022]), a storage router creates a unique storage node for each storage enclosure discovered in the SAS/SATA storage domain. The storage router creates each storage node during a device discovery stage by querying the SAS expansion processor (expander) within a storage enclosure for details of the enclosure and its full inventory of installed target devices. In other words, the storage router creates each storage node using its router discovery module to query the expansion processor (expander) within a storage enclosure for details of the enclosure and its full inventory of installed target devices. Target devices reported by the expander are assigned to the enclosure's unique storage node and unique target identifier. A LUN identifier is also assigned corresponding to the target device's reported slot number. In one aspect, this grouping establishes an affinity among co-located target devices. If the expander reports an empty slot, that LUN identifier is reserved by the storage router for future expansion. In an exemplary embodiment, once target discovery has completed, the storage node and target records are saved in the storage router's persistent storage so that a consistent view of the storage can be preserved across storage router power-cycles, resets or re-cabling. Expanders which are not directly connected to storage targets are not registered or presented as storage nodes into the SAN namespace.

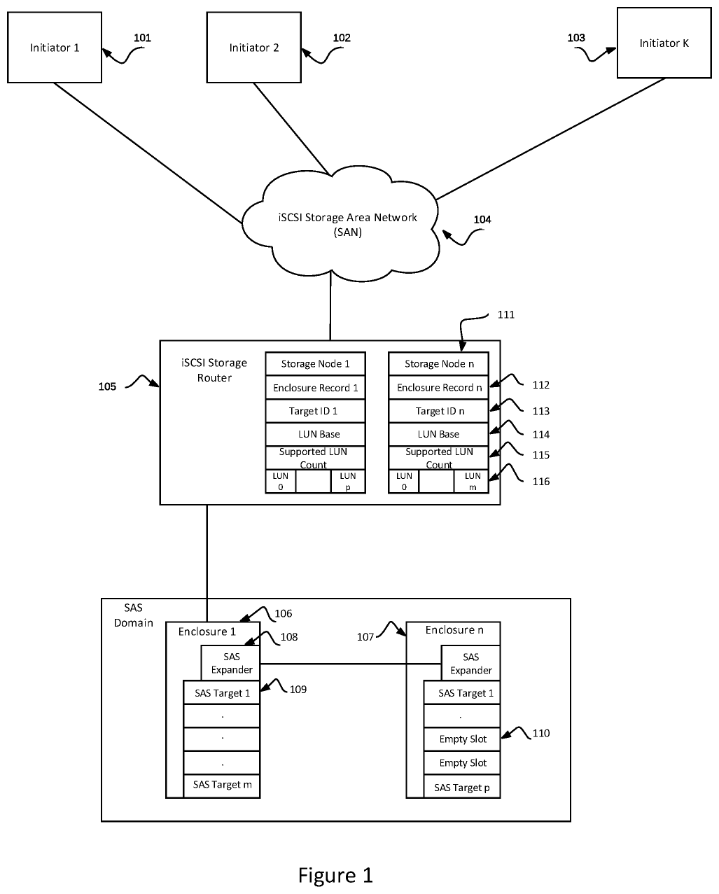

FIG. 1 illustrates an exemplary storage router in this environment. A number K of initiator workstations 101,102,103 are connected to an iSCSI storage area network (SAN) 104. An iSCSI storage router 105 is connected between the SAN 104 and a number n of SAS enclosures 106,107. In this embodiment, each enclosure has at least one SAS expander 108 and a number of SAS targets 109. An enclosure may also have drive slots which are empty 110. The storage router creates a storage node 111 and enclosure record 112 for each enclosure discovered in the SAS domain. Each enclosure record has a corresponding target identifier 113 and LUN identifier 116 used to assist in the grouping and presentation of the SAS devices into the SAN namespace via its storage node. Enclosure records also contain information to assist with LUN identifier assignment during discovery. The LUN base 114 stores the lowest numbered LUN identifier within this enclosure and the supported LUN count 115 stores the number of LUNs supported by the enclosure.

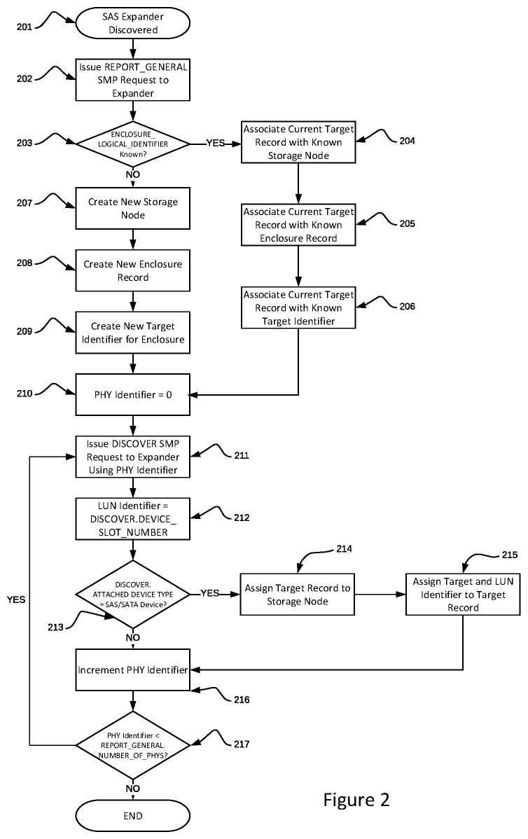

An exemplary target discovery process is shown in FIG. 2. In this embodiment, a SAS expander is discovered 201 during the normal SAS target discovery process. For simplicity, this expander may be assumed to be part of a drive enclosure and capable of relaying enclosure properties. A REPORT_GENERAL SMP request 202 is issued to the expander. The corresponding REPORT_GENERAL SMP response is examined to determine if the ENCLOSURE LOGICAL IDENTIFIER reported by the expander is associated with a target device previously grouped into a storage node by the storage router 203. If the identifier has been previously discovered, the device's stored target record and enclosure record are retrieved from the storage router's nonvolatile storage 204,205 and the current target identifier is used for this discovery 206. If the ENCLOSURE LOGICAL IDENTIFIER is unknown by the storage router, a storage node, enclosure record and target identifier are created 207,208,209 to be used in the presentation of a new storage node on the SAN.

In the embodiment illustrated in FIG. 2, a local loop variable known as the PHY identifier is initialized 210 and a series of DISCOVER SMP requests are issued to the expander 211. The DISCOVER SMP response contains a DEVICE SLOT NUMBER field, which is validated and assigned into a temporary LUN identifier variable 212. In certain aspects, the expander may return responses for PHY identifiers without a physical target attached, for example an empty slot or an expander to expander connection. If a physical target is reported 213, a target record is created and assigned to the associated storage node 214, and the target record is updated with an association between the physical device and the target and LUN identifier 215. The PHY identifier is then incremented and the discovery is issued for every device reported by the expander 216, 217.

Once SAS discovery has completed, the storage router in a preferred embodiment will write the storage node and target record data into nonvolatile storage, preserving target identifier and LUN assignments in case of power loss or target device failure and SAS rediscovery. In certain aspects, storage nodes and their target records can be managed by a user via any one of the storage router's management interfaces, including graphical user interface, SSH command line, or serial command line interface. In other aspects, storage nodes can be copied and renamed, while target records can be moved between storage nodes for further administrator flexibility and ease of management. If target devices are permanently removed from the SAS domain, associated storage nodes and target records may also be deleted.

While the presently preferred forms of an improved system and method for predictive grouping and presentation of target devices in a storage router have been shown and described, and several modifications thereof discussed, persons skilled in this art will readily appreciate that various other and further changes and modifications may be made without departing from the spirit or scope of the invention, as defined and differentiated by the claims. The present embodiments described herein are to be considered as illustrative and not restrictive.

What is claimed is:

1. A storage router communicatively connectable to a plurality of target storage devices having a physical layout, comprising:
an expansion processor within a storage enclosure;
a router discovery module in communication with said expansion processor, said router discovery module configured to discover the physical layout of said target storage devices within said storage enclosure;
a iSCSI/iSER host system interface for receiving and responding to data storage commands;
a SAS/SATA interface for communicating with said plurality of target storage devices; and
a plurality of iSCSI/iSER host system interface storage nodes containing device maps corresponding to said physical layout of said target storage devices.

2. The storage router of claim 1, wherein said storage enclosure is configured to report an enclosure identifier and to report said physical layout by means of an associated characteristic parameter.

3. The storage router of claim 2, wherein said host system interface storage nodes contain target storage device maps grouped by said enclosure identifier and ordered by said associated characteristic parameter.

4. The storage router of claim 2, wherein said associated characteristic parameter is target device slot number or target PHY identifier.

5. The storage router of claim 2, further comprising: an empty target device map to account for each gap in said associated characteristic parameter.

6. The storage router of claim 1, wherein said iSCSI/iSER host system interface storage nodes and target storage device maps are stored in nonvolatile storage, to preserve a consistent view across storage router failures, power-cycles, resets or re-cabling.

7. A method of mapping target storage devices in a storage router system comprising:
providing an iSCSI/iSER host system interface for receiving and responding to data storage commands;
providing a plurality of target storage devices within a storage enclosure;
discovering the physical layout of said target storage devices; and
creating a plurality of iSCSI/iSER host system interface storage nodes containing target storage device maps corresponding to said physical layout of said target storage devices within said storage enclosure.

8. The method of claim 7, further comprising:
providing nonvolatile storage; and
writing said host system interface storage nodes and target storage device maps to said nonvolatile storage, such that a consistent view is preserved across storage router failures, power-cycles, resets or re-cabling.

9. The method of claim 7 wherein said storage enclosure reports an enclosure identifier and said physical layout by means of an associated characteristic parameter.

10. The method of claim 9, further comprising:
querying said storage enclosure to report said enclosure identifier and said characteristic parameter;
wherein said host system interface storage nodes are created and where target device maps are grouped by said enclosure identifier and said characteristic parameter.

11. The method of claim 9, wherein said characteristic parameter is target device slot number or target PHY identifier.

12. The method of claim 9, further comprising:
analyzing said characteristic parameter for gaps; and
creating an empty storage device map to account for each gap.

13. The method of claim 7, further comprising:
copying, renaming or deleting a host system interface storage node; and
manual adding or removing said target storage device maps within said host system interface storage node.

14. The method of claim 7, further comprising:
presenting said host system interface storage nodes to initiators on the storage area network.

15. A system within a storage area network, for establishing predictive grouping and presentation of target devices contained within a single physical enclosure, comprising:
a storage router in communication with a plurality of initiators;
a plurality of target storage devices in a storage area network;
a first physical storage enclosure containing more than one of said target storage devices;
a router discovery module within said storage router configured to discover the physical layout of said target storage devices and to discover which of said target storage devices are contained within said first physical storage enclosure;
a storage node comprising a plurality of target devices and a list of initiator devices that have access privileges to said target devices, said storage node corresponding to said single physical storage enclosure;
wherein said storage router presents said first storage node to one or more of said initiators.

16. The system of claim 15, further comprising:
an expansion processor in communication with said router discovery module.

17. The system of claim 15, further comprising:
a second physical storage enclosure; and
a unique second storage node comprising a plurality of target devices and a list of initiator devices that have access privileges to said target devices, said second storage node corresponding to said second physical storage enclosure.

18. The system of claim 15 wherein said storage router is an iSCSI/iSER to SAS/SATA storage router.
